(19) United States
(12) Patent Application Publication
(10) Pub. No.: US 2014/0170967 A1
(43) Pub. Date: Jun. 19, 2014

(54) WIRELESS POWERED IC CARD FOR SENSOR DATA ACQUISITION, PROCESSING AND RADIO FREQUENCY TRANSMISSION

(71) Applicant: TEXAS INSTRUMENTS INCORPORATED, Dallas, TX (US)

(72) Inventors: Alain Bruno CHATEAU, Cagnes sur Mer (FR); Vasile ZOICAS, La Gaude (FR)

(73) Assignee: TEXAS INSTRUMENTS INCORPORATED, Dallas, TX (US)

(21) Appl. No.: 13/715,688

(22) Filed: Dec. 14, 2012

(30) Foreign Application Priority Data
Dec. 13, 2012 (EP) 12290438.6

(51) Int. Cl. H04B 5/00

(52) U.S. Cl. CPC H04B 5/0037
USPC 455/41.1

(57) ABSTRACT

An integrated circuit card includes a rechargeable energy source, a wireless transmitter, and a processor. The processor receives sensor data from one or more sensors and sends the sensor data to the wireless transmitter for wireless transmission.

### CROSS-REFERENCE TO RELATED APPLICATION

The present application claims priority to European Patent Application No. 12290438.6, filed on Dec. 13, 2012 (Attorney Docket No. TI-71034); which is hereby incorporated herein by reference.

### BACKGROUND

Industries such as the healthcare industry or industries that rely on environmental monitoring require accurate and up-to-date information from various types of sensors. For example, in the healthcare industry, a patient's vital signs may be monitored by a healthcare professional to ensure the patient remains in good health. As another example, in the chemical process industry, environmental conditions in the work place such as concentration of atmospheric elements, atmospheric pressure, ambient temperature and humidity and the like may be monitored to ensure that workers are not exposed to dangerous conditions, or to quickly remedy any such dangerous condition.

Current sensors are bulky and typically connected to a monitoring device (e.g., an ECG monitoring device or an environmental condition monitoring device) via a wired connection. Certain wearable monitors may be used; however, these monitors are also bulky and are worn in a cumbersome manner, such as a holster, belt, or chest strap. Additionally, current sensors themselves rarely include any embedded processing capability, requiring the monitoring device to perform all processing of sensor data.

### SUMMARY

Embodiments of the present disclosure are directed to an integrated circuit card that includes a rechargeable energy source, a wireless transmitter, and a processor. The processor receives sensor data from one or more sensors and sends the sensor data to the wireless transmitter for wireless transmission.

Other embodiments of the present disclosure are directed to a wireless sensor system that includes a sensor, an integrated circuit card, and a monitoring device to receive the sensor data from the integrated circuit card. The integrated circuit card includes a rechargeable energy source, a wireless transmitter, and a processor. The processor receives sensor data from the sensor and sends the sensor data to the wireless transmitter for wireless transmission.

Still other embodiments of the present disclosure are directed to a method of processing sensor data with an integrated circuit card that includes receiving sensor data from a sensor, sending the sensor data to a wireless transmitter for wireless transmission, and recharging a rechargeable energy supply of the integrated circuit card wirelessly through an inductive power coupling.

### BRIEF DESCRIPTION OF THE DRAWINGS

For a detailed description of exemplary embodiments of the invention, reference will now be made to the accompanying drawings in which:

FIG. 1 shows a wireless sensor system in accordance with various embodiments;

FIG. 2 shows an exemplary sensor data processing system in accordance with various embodiments;

FIG. 3 shows another exemplary sensor data processing system in accordance with various embodiments; and

FIG. 4 shows a flow chart of a method in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct electrical connection. Thus, if a first device couples to a second device, that connection may be through a direct electrical connection, or through an indirect electrical connection via other devices and connections.

As used herein, the term “integrated circuit (IC) card” or “smart card” refers to a card that contains an embedded integrated circuit. In some cases, the card may be similar in size to a credit card.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

In accordance with various embodiments, a powered integrated circuit (IC) card or a so-called “smart” card includes modules to acquire data from one or more sensors, optionally process the sensor data, and wirelessly transmit the sensor data or processed sensor data to a monitoring device. Additionally, the IC card may control or stimulate actuators, for example an electrode to fix a skin reference voltage, and receive actuation data from such actuators. The IC card is powered by an energy source, such as a battery, that is rechargeable. Prior art IC cards are not typically self-powered and rely on the card reader to supply power. Only a small fraction of prior art IC cards are self-powered and their form factor prevents recharging; thus, prior art powered IC cards are rendered useless when their battery dies.

In accordance with various embodiments, an IC card is provided with a rechargeable energy source, which may be charged wirelessly through, for example, an inductive power coupling or thermal energy harvesting (e.g., from body heat using a thermocouple). In certain applications, such as smart buildings or intelligent industrial environments, the IC card may be wirelessly charged using other technologies, such as radio frequency (RF) coupling (e.g., infrared (IR) or ultra-high frequency (UHF) couplings) or other similar wireless power transmission technologies. In some embodiments, a universal serial bus (USB) connection such as a micro- or mini-USB connector enables a second method of charging. The IC card receives sensor data from the sensors, which may include wearable electronic sensors (e.g., smart textiles) to detect human vital signs, environmental conditions and the like. In some embodiments, the sensors comprise woven textile electrodes that detect ECG data or other vital signs of a patient wearing the smart textile. In other embodiments, the sensors comprise environmental sensors that may detect, for example, atmospheric pressure, temperature, humidity, concentration of certain elements or compounds, presence of hazardous materials and the like. In other embodiments, the sensors comprise motion sensors. Additionally, the present disclosure is not limited by the type of sensor; rather, the IC card and monitoring system may be used with many different types of sensors. The IC card may comprise a direct current (DC) coupler on its surface to make contact with corresponding contacts of the sensors and receive sensor data through the DC coupler. Alternately or additionally, the IC card may comprise a wireless receiver (or “sensor data receiver”) that receives sensor data wirelessly. In addition, the IC card may itself comprise a sensor.

As explained above, the IC card may also include an actuator such as a drive electrode. For example, where used in an ECG system, the IC card may include two or more electrodes that monitor the voltage across one or more leads. In addition to these monitoring electrodes, a right-leg drive (RLD) electrode may be required to bias a node (e.g., skin of a patient) to a set DC operating point in order to ensure that the input is at the same potential as the sensors or monitoring system.

The IC card also includes a wireless transmitter and a processor. The processor receives sensor data and sends sensor data to the wireless transmitter for wireless transmission to, for example, a monitoring device. The wireless transmitter may transmit using various wireless protocols that transmit over the radio-frequency (RF) spectrum. In some embodiments, the processor processes the sensor data before sending the processed sensor data to the wireless transmitter, while in other embodiments the processor sends raw sensor data to the wireless transmitter. In some cases, the IC card includes a wireless receiver and the processor receives data from the receiver, for example to drive an actuator. The processor may use received data to configure the sensor and/or actuator and may support reconfiguration of either in an on-the-fly and/or over the air manner.

In some embodiments, a wireless sensor system includes a monitoring device, on which a monitoring application may be executed, in addition to a sensor and IC card as described above. The monitoring device receives data (e.g., sensor data or processed sensor data) wirelessly from the IC card. The monitoring application may further process and display or otherwise convey the received data to a user. For example, where the sensors comprise electrodes that detect ECG data or other vital signs, the monitoring device may display ECG waveforms, visual indications of vital signs, and the like. The monitoring device also may include hardware that enables a connection to a network (e.g., a local-area network (LAN), a wide-area network (WAN), or the Internet) to share data with other devices. For example, upon the detection of an alert condition such as an irregular heartbeat, the monitoring device may both display the patient's ECG waveform as well as generate an alert that is transmitted over the network to a health care provider's personal electronic device (e.g., a mobile phone, personal digital assistant (PDA), or personal computer). The present disclosure is not limited by the type of monitoring device; rather, the monitoring device may take many forms that interact with the described IC card.

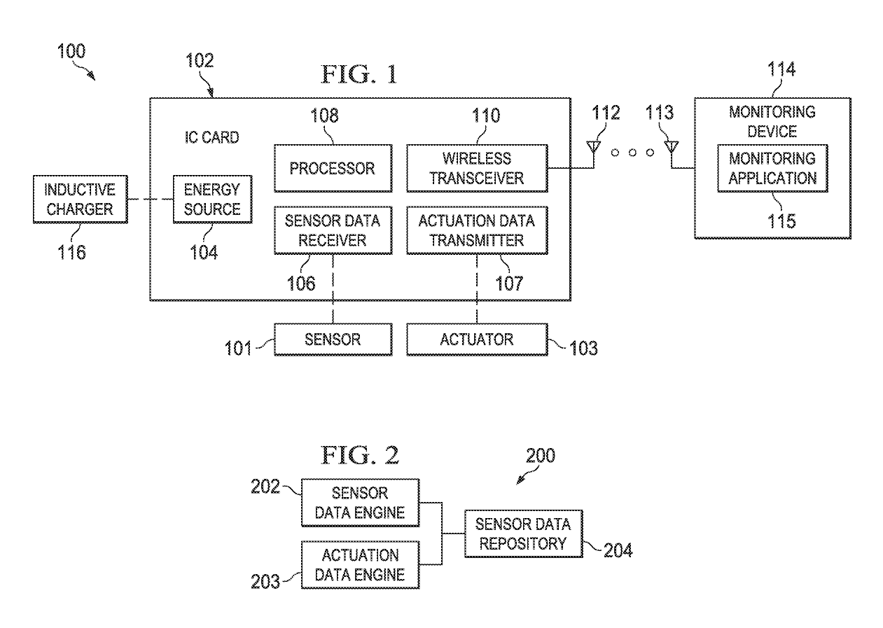

Turning now to FIG. 1, a wireless sensor system 100 is shown in accordance with various embodiments. The wireless sensor system 100 includes a sensor 101, an actuator 103, an IC card 102, and a monitoring device 114. The IC card 102 comprises an energy source 104, a sensor data receiver 106, an actuation data transmitter 107, a processor 108 and a wireless transceiver 110. Although not explicitly shown, the IC card 102 may also include other elements required for functionality, such as an energy manager to regulate and distribute power from the energy source 104; other such additions will be within the ambit of one skilled in the art. Additionally, one skilled in the art will appreciate that the wireless transceiver 110 is shown for convenience and, in certain embodiments, may comprise a separate wireless transmitter and receiver, or only one of a wireless transmitter and receiver.

The processor 108 receives sensor data from one or more sensors 101 through the sensor data receiver 106 and transfers actuation data to one or more actuators 103 through the actuation data transmitter 107. In some embodiments, the sensor data receiver 106 and/or the actuation data transmitter 107 may comprise a direct current (DC) coupler on the surface of the IC card 102. In these embodiments, the IC card 102 may be positioned in a way such that the DC coupler 106, 107 makes contact with corresponding sensor and/or drive leads, for example leads embedded in a receiving pocket of a smart textile device or leads otherwise configured to engage the DC coupler 106, 107 when the IC card 102 is positioned accordingly. In other embodiments, the sensor data receiver 106 may comprise a wireless receiver that receives data wirelessly from various sensors 101 and the actuation data transmitter 107 may comprise a wireless transmitter that transmits data wirelessly to various actuators 103. The present disclosure is not limited to a particular type of sensor data receiver 106 or actuation data transmitter 107; rather, the sensor data receiver 106 may be any receiver that receives data from sensors 101, and which may then transmit the sensor data to the processor 108. Similarly, the actuation data transmitter 107 may be any transmitter that transmits data to actuators 103, which may have been received from the processor 108.

In accordance with various embodiments, the processor 108 receives sensor data from the sensor 101. In some embodiments, the processor 108 may receive the sensor data via the sensor data receiver 106, while in other embodiments the processor 108 comprises the sensor data receiver 106 and thus receives data from the sensor 101 directly. The processor 108 sends the sensor data to the wireless transceiver 110 for wireless transmission. In some embodiments, the processor 108 processes the sensor data (e.g., applies various algorithms to the sensor data, determines whether the sensor data is above or below a threshold, determines whether certain conditions are met based on analysis of the sensor data, applies data from another sensor to adapt the processing of the sensor data, or parameterizing the processing based on information received over the air from the wireless transceiver 110) prior to sending to the wireless transceiver 110 whereas in other embodiments the processor 108 sends raw sensor data to the wireless transceiver 110 for wireless transmission. The wireless transceiver 110 may comprise a physical layer (PHY) that transmits data wirelessly over a wireless antenna 112 according to a known wireless communication protocol (e.g., Bluetooth, IEEE 802.11x, IEEE 1451.x, IEEE 802.15x, Zigbee, WirelessHART, or Z-wave).

The processor 108 may also control the operation of the sensor data receiver 106 and/or the actuation data transmitter 107 based on the operation characteristics of either. For example, the processor 108 may cause the configuration of the sensor data receiver 106 (e.g., its dynamics, noise filtering, or amplification) to be modified based on received sensor data from either the sensor data receiver 108 or another sensor data receiver. Similarly, the processor 108 may modify the operating mode (e.g., sampling frequency) of the sensor data receiver 106 as well. As another example, the processor 108 may control conditional activation of certain sensors or sensor data receivers. In this case, it may be beneficial to only activate power-hungry sensors and/or sensor data receivers based on information received from another sensor and sensor data receiver. For example, the processor 108 may activate a compass sensor based on data received from an accelerometer sensor and, because the compass sensor consumes more power than the accelerometer sensor, overall power consumption of the system is reduced. Although not explicitly shown, the sensor 101, actuator 103, sensor data receiver 106, and actuation data transmitter 107 may comprise individual wireless antennas to enable wireless communication as described above.

In accordance with various embodiments, the energy source 104 provides power to the components of the IC card 102. In some embodiments, the energy source 104 may be recharged by placing the IC card 102 proximate an inductive charger 116. The inductive charger 116 provides an inductive power coupling to the energy source 104 such that the energy source 104 is recharged wirelessly and without the need to couple the IC card 102 to a charging source via a physical connector. In other embodiments, the IC card 102 comprises, for example, a USB port that enables charging of the energy source 104 via a physical connector as a secondary or backup charging method.

The sensor 101 may include a wearable electronic sensor (e.g., smart textiles) to detect human vital signs, environmental conditions and the like. In some embodiments, the sensor 101 comprises woven textile electrodes that detect ECG data or other vital signs of a patient wearing the smart textile. In other embodiments, the sensor 101 comprises an environmental sensor that may detect, for example, atmospheric pressure, temperature, humidity, concentration of certain elements or compounds, presence of hazardous materials, and the like. In other embodiments, the sensor 101 comprises a motion sensor that may detect, for example, physical activity of a human wearing the sensor 101.

The monitoring device 114 may execute a monitoring application 115 and include a wireless transceiver (not shown). The monitoring device 114 receives data (e.g., sensor data or processed sensor data) wirelessly via its wireless transceiver and a corresponding wireless antenna 113 from the IC card 102. The monitoring application 115 may further process and display or otherwise convey the received data to a user. For example, where the sensor 101 comprises an electrode that detects ECG data or other vital signs, the monitoring device 114 may display ECG waveforms, visual indications of vital signs, generate alarms informing the user of any detection of an ECG anomaly, and the like. The monitoring application 115 may also process received data and, based on operating policies or user inputs, produce real-time feedback control or configuration data to the IC card 102 to change an operating mode of the IC card 102. For example, configuration parameters relating to analog-to-digital conversion (ADC) dynamics to optimize a signal-to-noise ratio (SNR) may be updated based on the processing of data received from the IC card 102, thereby permitting adaptive sensing. The monitoring device 114 also may include hardware (not shown) that enables a connection to a network (e.g., a local-area network (LAN), a wide-area network (WAN), or the Internet) to share data with other remote devices, store data in a storage server pool (e.g., cloud storage) or rely on shared computing resources for further data processing (e.g., cloud computing). For example, upon the detection of an alert condition such as an irregular heartbeat or pathological ECG waveform, the monitoring device 114 may both display the patient's ECG waveform as well as generate an alert that is transmitted over the network to a health care provider's personal electronic device (e.g., a smart phone, a mobile phone, personal digital assistant (PDA), or personal computer). Additionally, in some embodiments, the monitoring device 114 may itself comprise such a personal electronic device; that is, for example, a smart phone may be a monitoring device 114 in certain applications.

FIG. 2 shows a sensor data processing system 200 in accordance with various embodiments. The sensor data processing system 200 is implemented on an IC card, such as the IC card 102 described above with respect to FIG. 1. The sensor data processing system 200 includes a sensor data engine 202, an actuation data engine 203, and a sensor data repository 204 coupled to the sensor data engine 202 and the actuation data engine 203. The sensor data engine 202 and actuation data engine 203 are combinations of programming and hardware to execute the programming. Although shown as separate engines, the sensor data engine 202 and the actuation data engine 203 are not required to represent different pieces of software programming. For example, the sensor data engine 202 and the actuation data engine 203 may share a common processor and memory, or may be applied across multiple processors and/or memories. Additionally, the programming that enables the functionality of the sensor data engine 202 and the actuation data engine 203 may be included in the same executable file or library or across multiple executable files or libraries.

The sensor data engine 202 receives sensor data from one or more sensors, such as sensor 101 described above with respect to FIG. 1. In some embodiments, the sensor data engine 202 may receive the sensor data from a sensor data receiver, such as the sensor data receiver 106 described above with respect to FIG. 1, while in other embodiments the sensor data engine 202 receives data from a sensor directly. The sensor data engine 202 sends the sensor data to a wireless transceiver for wireless transmission. In some embodiments, the sensor data engine 202 processes the sensor data (e.g., applies various algorithms to the sensor data, determines whether the sensor data is above or below a threshold, determines whether certain conditions are met based on analysis of the sensor data, applies data from another sensor to adapt the processing of the sensor data, or parameterizing the processing based on information received over the air from the wireless transceiver 110) prior to sending to the wireless transceiver whereas in other embodiments the sensor data engine 202 sends raw sensor data to the wireless transceiver for wireless transmission.

Additionally, as explained above, the actuation data engine 203 may receive actuation data, for example from the wireless transceiver 110 via the processor 108, and transfer the actuation data to one or more actuators 103 through the actuation data transmitter 107 as shown in FIG. 1. In some embodiments, the actuation data engine 203 transfers the actuation data to an actuator directly. In some embodiments, the actuation data engine 203 processes the actuation data prior to sending to the actuator whereas in other embodiments, the actuation data engine 203 sends raw actuation data to the actuator.

The data repository 204 may store sensor data prior to processing of the sensor data by the sensor data engine 202, after processing of the sensor data by the sensor data engine 202 and prior to transmitting the processed sensor data, and/or after transmitting the processed sensor data. The data repository 204 also may store actuation data prior to processing of the actuation data by the actuation data engine 203, after processing of the actuation data by the actuation data engine 203 and prior to transmitting the processed actuation data, and/or after transmitting the processed actuation data. In some embodiments, the data repository 204 allows the sensor data engine 202 and/or the actuation data engine 203 to perform a history-based analysis or processing of various sensor or actuation data.

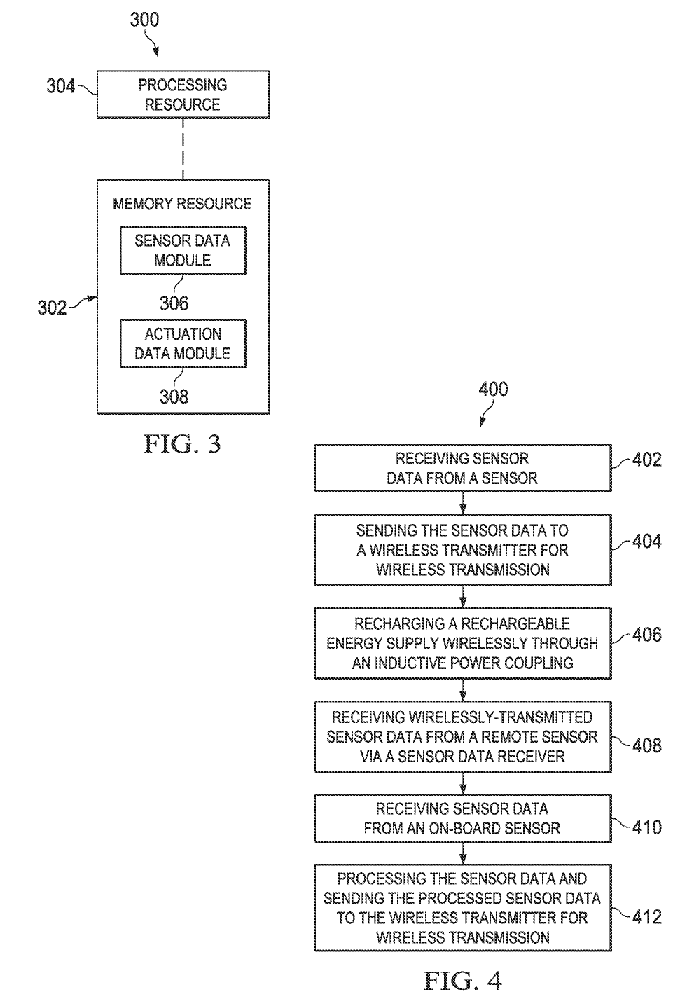

FIG. 3 shows another example of a sensor data processing system 300 in accordance with various embodiments. As above, the sensor data processing system 300 is implemented on an IC card, such as the IC card 102 described above with respect to FIG. 1. The sensor data processing system 300 includes a memory resource 302 coupled to a processing resource 304. The processing resource 304 is one or more local or distributed processors. The memory resource 302 includes one or more local or distributed memory devices and comprises a sensor data module 306 and an actuation data module 308. Thus, the memory resource 302 and the processing resource 304 are hardware components of the system 300.

The sensor data module 306 and the actuation data module 308 represent instructions that, when executed by the processing resource 304, implement an associated engine. For example, when the sensor data module 306 is executed by the processing resource 304, the above-described sensor data engine 202 functionality is implemented. Similarly, when the actuation data module 308 is executed by the processing resource 304, the above-described actuation data engine 203 functionality is implemented. The sensor data module 306 and the actuation data module 308 may also be implemented as an installation package or packages stored on the memory resource 302, which may be a CD/DVD or a server from which the installation package may be downloaded. Additionally, in some embodiments, the above-described functionality may be implemented in an application-specific integrated circuit (ASIC), a combination of an ASIC and software, or an application-specific instruction-set processor (ASIP).

FIG. 4 shows a method 400 in accordance with various embodiments. The method 400 begins in block 402 with receiving sensor data from a sensor. For example, as explained above, the processor 108 may receive the sensor data via the sensor data receiver 106 or the processor 108 may comprise the sensor data receiver 106 and thus receives data from the sensor 101 directly. The method 400 continues in block 404 with sending the sensor data to a wireless transceiver for wireless transmission. For example, the processor 108 sends the sensor data to the wireless transceiver 110 for wireless transmission. The wireless transceiver 110 may comprise a physical layer (PHY) that transmits data wirelessly over a wireless antenna 112 according to a known wireless communication protocol (e.g., Bluetooth, IEEE 802.11x, IEEE 1451.x, IEEE 802.15x, Zigbee, WirelessHART, or Z-wave). The method 400 then continues in block 406 with recharging a rechargeable power supply wirelessly through an inductive power coupling.

The method 400 may continue in block 408 with receiving wirelessly-transmitted sensor data from a remote sensor via a sensor data receiver. Additionally, the method 400 may also continue in block 410 with receiving sensor data from an on-board sensor. Finally, the method 400 may continue in block 412 with processing the sensor data and sending the processed sensor data to the wireless transceiver for wireless transmission. In some embodiments, the processor 108 processes the sensor data (e.g., applies various algorithms to the sensor data, determines whether the sensor data is above or below a threshold, determines whether certain conditions are met based on analysis of the sensor data, applies data from another sensor to adapt the processing of the sensor data, or parameterizing the processing based on information received over the air from the wireless transceiver 110) prior to sending to the wireless transceiver 110 whereas in other embodiments the processor 108 sends raw sensor data to the wireless transceiver 110 for wireless transmission.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. An integrated circuit card, comprising:
a rechargeable energy source;
a wireless transmitter; and
a processor that:
receives sensor data from one or more sensors; and
sends the sensor data to the wireless transmitter for wireless transmission.

2. The integrated circuit card of claim 1 wherein the rechargeable energy source recharges wirelessly through an inductive power coupling.

3. The integrated circuit card of claim 1 further comprising a direct current coupler on a surface of the integrated circuit card, wherein the processor receives sensor data from the direct current coupler.

4. The integrated circuit card of claim 1 further comprising a sensor data receiver, wherein the processor receives wirelessly-transmitted sensor data from a remote sensor via the sensor data receiver.

5. The integrated circuit card of claim 1 further comprising an on-board sensor, wherein the processor receives sensor data from the on-board sensor.

6. The integrated circuit card of claim 1 further comprising an actuation data transmitter, wherein the processor transmits actuation data to one or more actuators via the actuation data transmitter.

7. The integrated circuit card of claim 1 wherein the processor processes the sensor data and sends the processed sensor data to the wireless transmitter for wireless transmission.

8. The integrated circuit card of claim 1 wherein the wireless transmitter transmits the sensor data via a radio frequency coupling.

9. A wireless sensor system, comprising:
a sensor;
an integrated circuit card, comprising:
a rechargeable energy source;
a wireless transmitter; and
a processor that:
receives sensor data from the sensor; and
sends the sensor data to the wireless transmitter for wireless transmission; and
a monitoring device to receive the sensor data from the integrated circuit card.

10. The wireless sensor system of claim 9 further comprising an inductive charger to recharge the rechargeable energy source via an inductive power coupling.

11. The wireless sensor system of claim 10 wherein the rechargeable energy source recharges wirelessly through an inductive power coupling with the inductive charger.

12. The wireless sensor system of claim 9 wherein the integrated circuit card further comprises a direct current coupler on a surface of the integrated circuit card, wherein the processor receives sensor data from the direct current coupler.

13. The wireless sensor system of claim 9 wherein the sensor is a remote sensor and the integrated circuit card further comprises a sensor data receiver, wherein the processor receives wirelessly-transmitted sensor data from the remote sensor via the sensor data receiver.

14. The wireless sensor system of claim 9 wherein the integrated circuit card further comprises an on-board sensor, wherein the processor receives sensor data from the on-board sensor.

15. The wireless sensor system of claim 9 further comprising an actuator, wherein the integrated circuit card further comprises an actuation data transmitter and the processor transmits actuation data to the actuator via the actuation data transmitter.

16. The wireless sensor system of claim 9 wherein the processor processes the sensor data and sends the processed sensor data to the wireless transmitter for wireless transmission.

17. The wireless sensor system of claim 9 wherein the wireless transmitter transmits the sensor data via a radio frequency coupling.

18. A method of processing sensor data with an integrated circuit card, comprising:
receiving sensor data from a sensor;
sending the sensor data to a wireless transmitter for wireless transmission; and
recharging a rechargeable energy supply of the integrated circuit card wirelessly through an inductive power coupling.

19. The method of claim 18 further comprising receiving sensor data from a direct current coupler on the surface of the integrated circuit card.

20. The method of claim 18 further comprising receiving wirelessly-transmitted sensor data from a remote sensor via a sensor data receiver of the integrated circuit card.

21. The method of claim 18 further comprising receiving sensor data from an on-board sensor of the integrated circuit card.

22. The method of claim 18 further comprising transmitting actuation data to an actuator via an actuation data transmitter of the integrated circuit card.

23. The method of claim 18 further comprising processing the sensor data and sending the processed sensor data to the wireless transmitter for wireless transmission.
